(19) United States
(12) Patent Application Publication
(10) Pub. No.: US 2002/0065672 A1
(43) Pub. Date: May 30, 2002

(54) Customizing method for ASP service

(76) Inventor: Shigeyoshi Shigeto, Tokyo (JP)

Correspondence Address: STAAS & HALSEY LLP, 700 11TH STREET, NW, SUITE 500, WASHINGTON, DC, 20001, US

(21) Appl. No.: 09/799,504

(22) Filed: Mar. 7, 2001

(30) Foreign Application Priority Data
Nov. 29, 2000 (JP) 2000-362789

(51) Int. Cl. G06F 17/60

(52) U.S. Cl. 705/1

(57) ABSTRACT

When data is sent as an HTML document from an ASP system, a server of a customer company converts information provided by the ASP into information of a customized format corresponding to a conversion logic and a table. The customize information is sent as an HTML document to a user terminal unit. On the other hand, the server of the customer company converts information that is input by the user into an HTML document of the format of the ASP system and sends the converted HTML document to the ASP system.

### BACKGROUND OF THE INVENTION

1. Field of the Invention

The present invention relates to a customizing method for an ASP service using an Internet web server.

2. Description of the Related Art

Nowadays, the Internet has been commonly used. Many companies have promoted the use of the Internet in their organizations. In addition, the contents of services of the Internet have been enriched day by day. It is expected that the Internet will be more actively used. As one service on the Internet, a business for structuring an application system on a web server and providing a part of a business of customer companies using a web server is becoming common. Such a business is referred to as application service provider (ASP).

In an Internet application service, a service of the ASP is directly provided to customer companies as users. However, depending on the content of a business, information provided by the ASP has to be converted into customer's information (screens, forms, information display sequence, and so forth). In such a case, customers should structure their original systems.

In other words, conventionally, when a customer company wants the ASP to provide company's customized service, company's customized program should be installed to the server of the ASP.

However, when customized programs for individual customer companies are installed to the server of the ASP, the cost of the ASP server rises. Thus, it is difficult to deal with needs of all customer companies.

### SUMMARY OF THE INVENTION

An object of the present invention is to provide a method for easily converting information provided by an ASP server into customer's customized information so that the customer can receive its customized ASP service.

The present invention is a customizing method for allowing a service provided by a service provider to be customized for a user who uses the customized service through a network, comprising the steps of (a) storing convention information that causes information transmitted from the service provider to be customized for the user and information transmitted from the user to be converted into a format of the service provider and (b) converting the information transmitted from the service provider into a format of the user and converting the information transmitted from the user into a format of the service provider using the conversion information.

According to the present invention, when the service provider provides a service corresponding to user's customizing request, it is not necessary to change the application software of the service provider. In other words, even if there are a plurality of customizing requests for the same contents, it is not necessary for the service provider to prepare a plurality of software programs having different interfaces.

When the customizing method according to the present invention is applied to a server or the like of the Intranet of a user side, confidential information added to customized information can be sufficiently suppressed from being wiretapped from a conventional subscriber line.

In addition, since the user side can provide its customized service to its users, the service provider can provide only a general purpose service. Thus, even if a plurality of users require differently customized services, the load applied to the service provider does not increase.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a schematic diagram showing an example of the overall structure of a system according to an embodiment of the present invention;

FIGS. 2A and 2B are schematic diagrams showing the flow of overall processes of the embodiment of the present invention;

FIG. 3 is a flow chart showing an outlined process of an ASP providing information logic;

FIG. 4 is a flow chart showing an outlined process of a user input information converting logic;

FIG. 5 is a flow chart sowing a process according to the embodiment of the present invention;

FIG. 6 is a schematic diagram showing an example of a quiz screen and a grade screen (No. 1);

FIG. 7 is a schematic diagram showing an example of a quiz screen and a grade screen (No. 2);

FIG. 8 is schematic diagram showing the content of an HTML document of a quiz screen;

FIG. 9 is a schematic diagram showing the content of an HTML document of a grade screen;

FIG. 10 is a flow chart showing a process of an account server;

FIG. 11 is a flow chart showing a process of a contents server;

FIG. 12 is a flow chart showing an interpretation process for a model;

FIG. 13 is a schematic diagram for explaining an interpretation process for a model file (No. 1);

FIG. 14 is a schematic diagram for explaining an interpretation process for a model file (No. 2);

FIG. 15 is a schematic diagram for explaining an interpretation process for a model file (No. 3);

FIG. 16 is a flow chart for explaining an expansion process for a model;

FIG. 17 is a flow chart showing an expansion process for one line of a model;

FIG. 18 is a schematic diagram for explaining the process at step S66 of FIG. 17;

FIG. 19 is a schematic diagram for explaining an expansion process for #repeat (No. 1);

FIG. 20 is a schematic diagram for explaining an expansion process for #repeat (No. 2);

FIG. 21 is a schematic diagram for explaining an expansion process for a #if statement (No. 1);

FIG. 22 is a schematic diagram for explaining an expansion process for a #if statement (No. 2);

FIG. 23 is a schematic diagram for explaining an expansion process for a #if statement (No. 3) and

FIG. 24 is a block diagram showing the structure of a hardware environment of an information apparatus that accomplishes the logic (algorithm) of the process of the embodiment of the present invention with a program.

### DESCRIPTION OF PREFERRED EMBODIMENT

According to an embodiment, a system that allows a user of a service on the customer company side to customize display screens and various information and manage a unique account is provided in an ASP business on the Internet.

Using a table and a program stored in a customer company system, information provided by the ASP is converted into information for users of the customer company. As a result, the user can use the service provided by the ASP as if it was customized for him or her. In addition, the system of the customer company can designate a unique account rather than an account designated by the ASP.

In other words, a customer server (a system of a customer company) stores a program and a table that convert information provided by the ASP into customized information. The information sent from the ASP is converted into customized information corresponding to the program and the table. Thereafter, the customized information is supplied to a customer terminal unit connected to the customer server. Likewise, information that is input from a customer terminal unit is converted into the format of the ASP corresponding to the program and the table. Thereafter, the converted information is sent to the ASP side. For example, units and calendar years (between Christian calendar and Japanese calendar) of the information are converted.

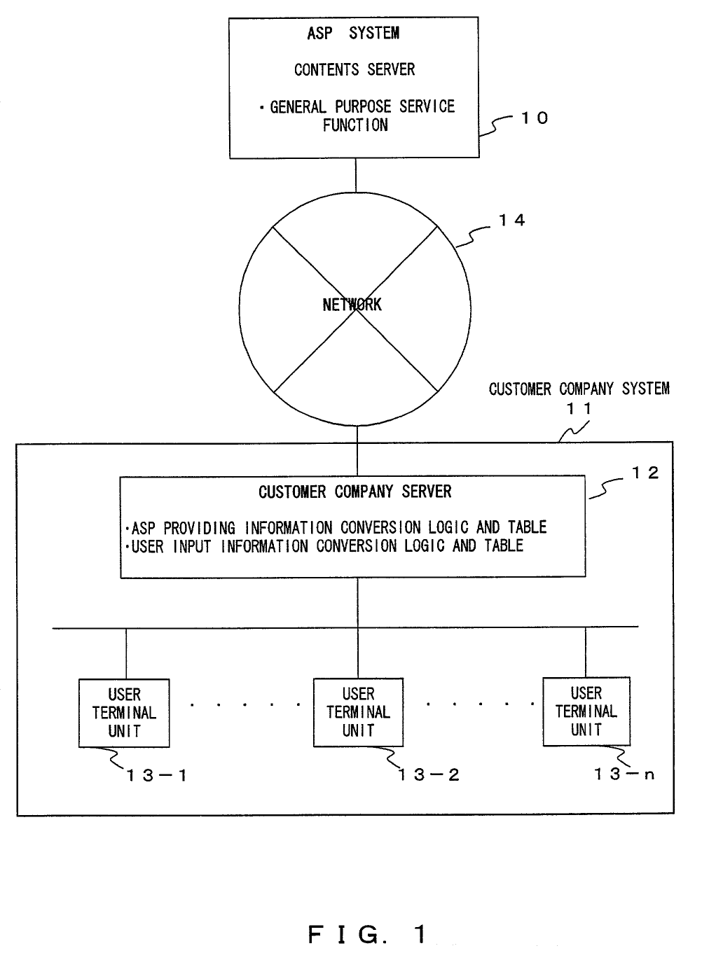

FIG. 1 is a schematic diagram showing an example of the structure of the overall system according to an embodiment of the present invention.

An ASP system (contents server) 10 and a customer company system 11 are connected through a network 14 such as the Internet. The ASP system 10 is provided with service contents and a function for accomplishing a service as a general purpose function. A customer company server 12 of the customer company system 11 stores an ASP providing information conversion logic, its table, a user input information conversion logic, and its table. The customer company server 12 and user terminals units 13-1 to 13-n are connected by a network such as a LAN (Local Area Network). Thus, the customer company server 12 cannot be accessed using a conventional subscriber line. As a result, even if confidential information is exchanged between the customer company server 12 and the user terminal units 13-1 to 13-n, the confidential information can be prevented from being wiretapped.

In the following description of the embodiment, it is assumed that an organization having a server such as the customer company server 12 subscribes to the ASP system 10 and uses it. However, it should be noted that the present invention is not limited to such an example. Instead, a general user may register himself or herself to the ASP system 10. In such a case, the terminal unit of the user functions as the customer company server 12.

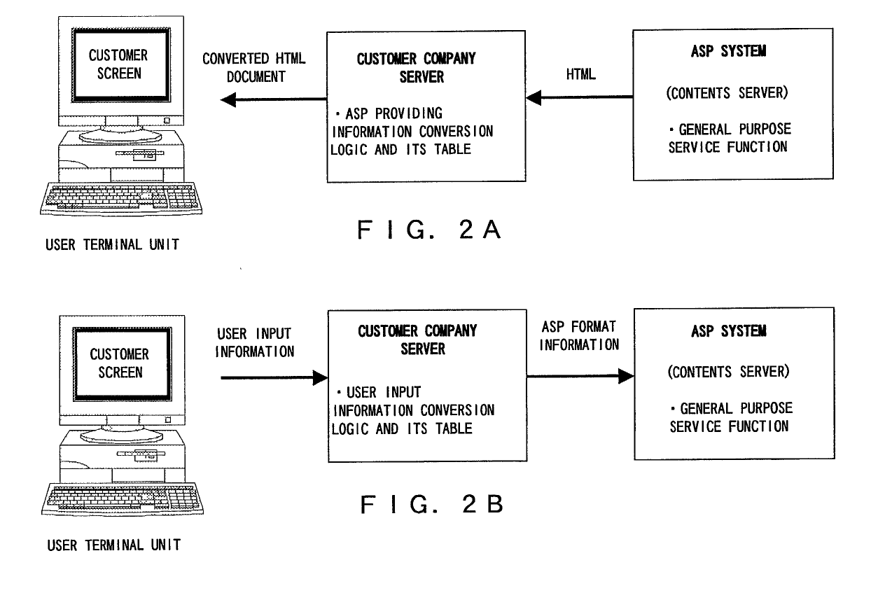

FIGS. 2A and 2B are schematic diagrams for explaining the overall process of the embodiment of the present invention.

As shown in FIG. 2A, an HTML document sent from the ASP is converted into customer's format by the ASP providing information conversion logic and its table of the customer company server. In addition, as shown in FIG. 2B, information that is input from the user terminal unit is converted into the ASP format by the user input information conversion logic and its table of the customer company server and then sent to the ASP side.

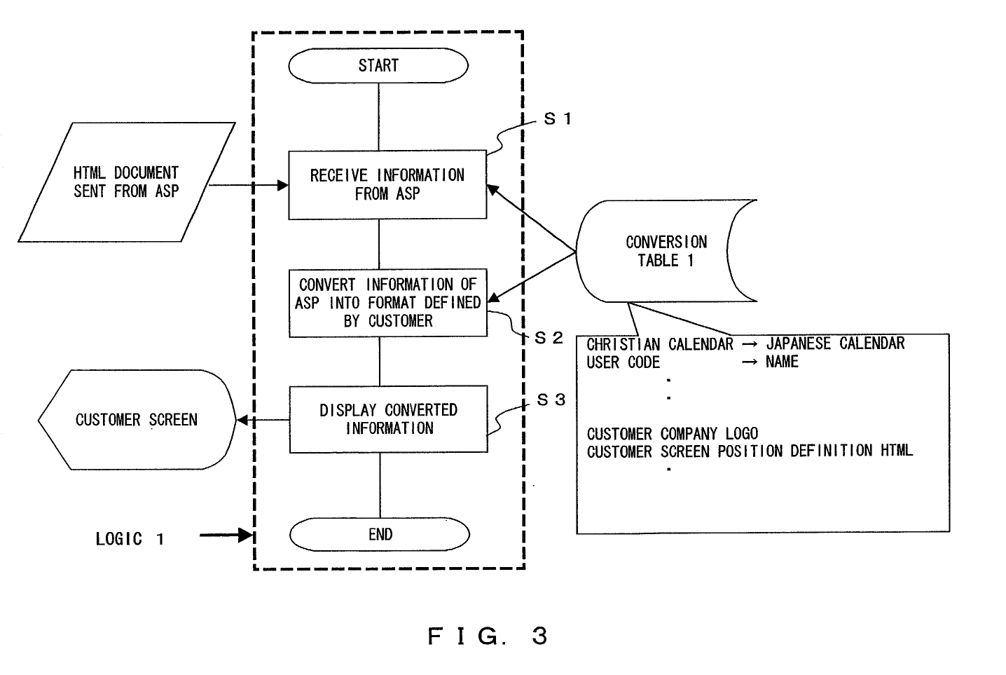

FIG. 3 is a flow chart showing an outlined process of the ASP providing information conversion logic.

A conversion logic 1 analyzes an HTML document received from the ASP, converts the HTML document into information corresponding to a conversion rule of a conversion table 1, embeds the converted HTML document into new customer's original HTML document created by the conversion logic 1, and sends the resultant HTML document to a user terminal unit.

At step S1, the conversion logic 1 receives an HTML document from the ASP. At step S2, the conversion table 1 references the conversion table 1 and converts the HTML document into a customer format. At step S3, the converted information is displayed on the customer screen. The content and real example of the conversion table will be described later. For example, the conversion table defines conversions from Christian calendar to Japanese calendar (or vice versa), from a user code to a name (or vice versa), addition of a customer company logo, and use of a customer screen position definition HTML.

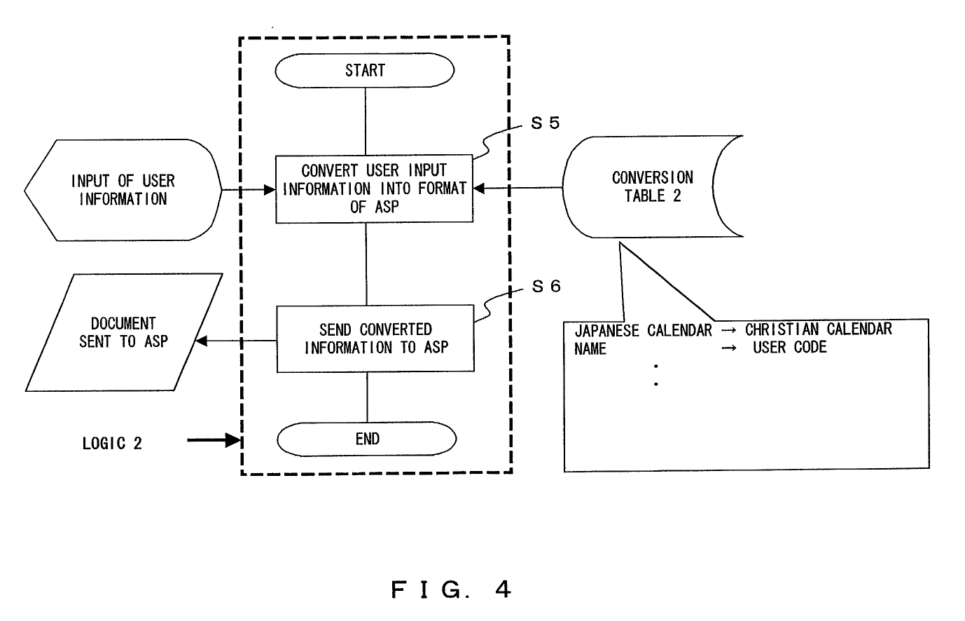

FIG. 4 is a flow chart showing an outlined process of the user input information conversion logic.

A conversion logic 2 converts information received from the user into format of the ASP corresponding to a conversion table 2. The converted information is sent to the ASP.

In other words, at step S5, the conversion logic 2 converts the information received from the user into the format of the ASP. At step S6, the converted information is sent to the ASP.

Next, as a service provided by the ASP, an online learning service according to an embodiment of the present invention will be described. However, it should be noted that the present invention is not limited to such an example.

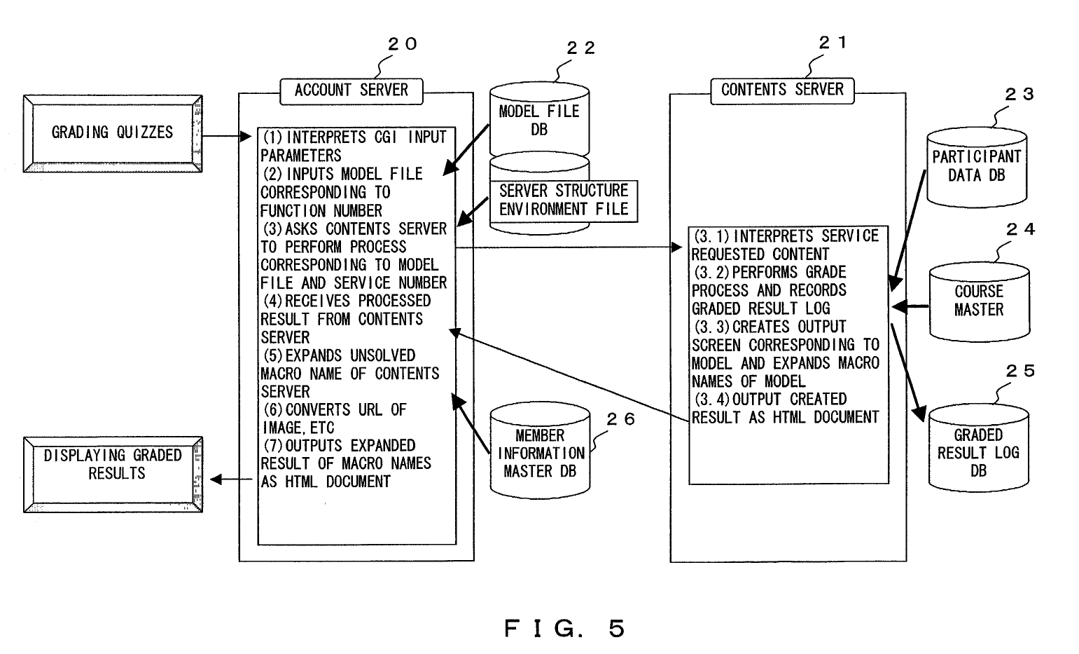

FIG. 5 is a schematic diagram showing a flow of a process of the embodiment of the present invention.

An account server 20 is a server of a customer company. A contents server 21 is a server of the ASP system.

In the example, the case that a user as an employee of a customer company uses an online learning service provided by the contents server 21, answers quizzes, and gets the score.

When the user asks the account server 20 to grade his or her answers, the account server 20 interprets cgi input parameters (as process (1)), reads a model file corresponding to a function number that identifies a function of the account server 20 from a model file DB 22 (as process (2)), and asks the contents server 21 to perform a process corresponding to the model file and a service number that identifies a service provided by the contents server 21 and that is extracted from the cgi parameters (as process (3)).

The contents server 21 interprets the content of the service request received from the account server 20 (as process (3. 1)), and performs the grade process and records the graded result log (as process (3. 2)). At that point, the contents server 21 references a participant data DB 23 and a course master DB 24 and writes the graded result log to a graded result log DB 25.

Participant data is a file stored in the contents server 21 that is open to the public. Member information is minimum data composed of a member number, a name (or handle name), and so forth necessary for operating a course. The course master is a file about a learning course. A course master is stored in the contents server 21. The course master is information about a learning course and contains the following items.

Information about entire course . . . course code, course name, fee, learning period, and so forth.

Information about learning unit . . . units of quizzes, information about structure of chapters, and so forth (for example, learning unit number, learning unit name, learning start date, learning end date, and quiz submission deadline)

Information about quizzes . . . information about grading criterion for quizzes (for example, quiz number, answer, allotment, and explanation) The graded result log is a file stored in the contents server 21. The graded result log is information of a graded result of a learner and a learning history.

Thereafter, the contents server 21 creates an output screen corresponding to a model (as process (3. 3)) and expands macro names in the model. Thereafter, the contents server 21 sends the created result as an HTML document to the account server 20 (as process (3. 4)).

When the account server 20 receives the processed result from the contents server 21 (as process (4)), the account server 20 expands an unsolved macro name of the contents server 21 with reference to a member information master DB 26 (as process (5)). The account server 20 converts an URL of an image (as process (6)). Thereafter, the account server 20 outputs the expanded result as an HTML document to the user terminal unit (as process (7)).

The member information master is a file stored in the account server. The member information master contains member information such as company name, section, member name, permanent address, daytime address, and mail address.

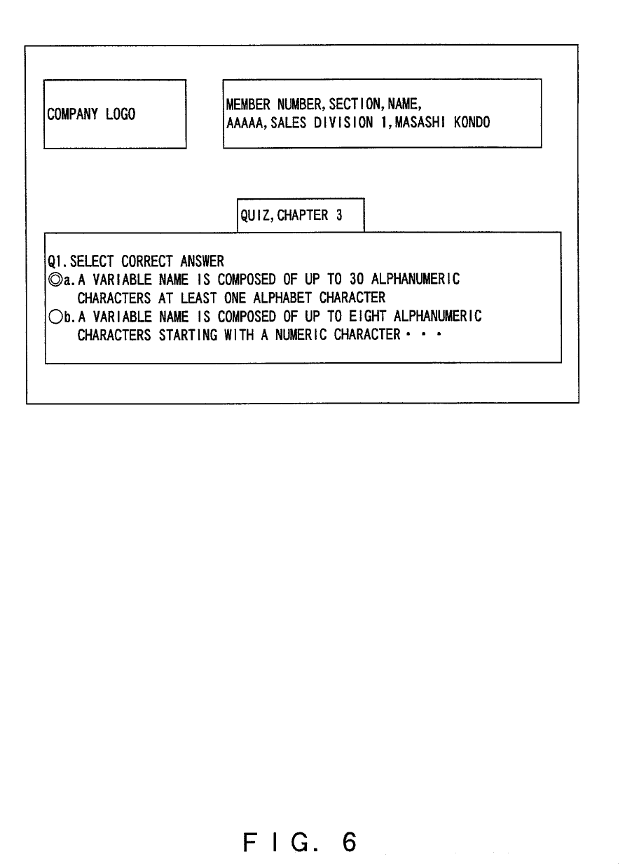

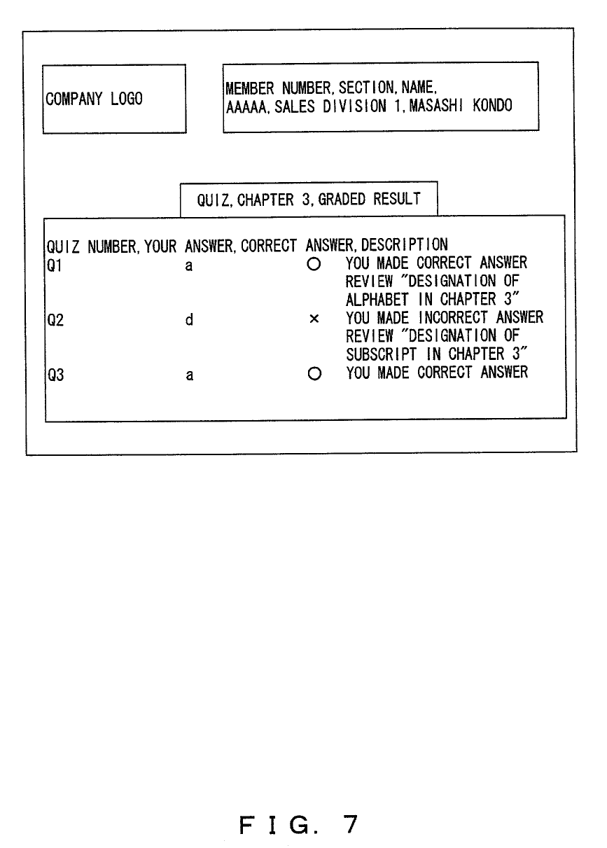

FIGS. 6 and 7 are schematic diagrams showing examples of a quiz screen and an grade screen.

FIG. 6 is a quiz screen displayed when the user answers a quiz. For the quiz screen, a model file designated by the account server 20 is used. In the example, the quiz screen displays a company logo, user's member number, user's section, and user's name along with a quiz. When the user answers the quiz and asks the system to grade the answer, a graded result is displayed as shown in FIG. 7 according to the flow shown in FIG. 5. For the screen shown in FIG. 7, the model file is also used. The grade screen displays a company logo, user's member number, user's section, and user's name along with a graded result.

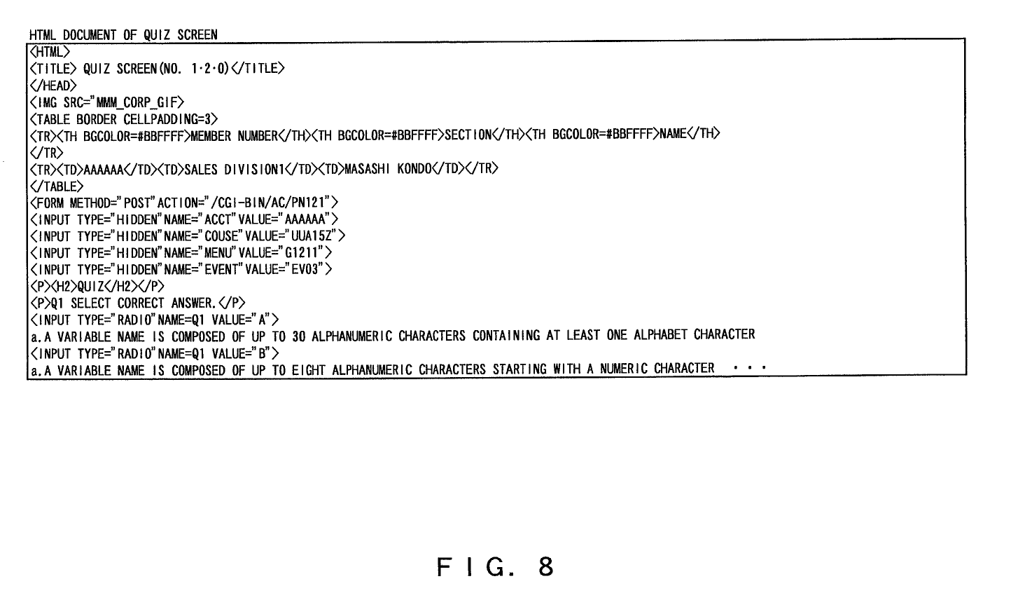

FIG. 8 shows the content of an HTML document of a quiz screen.

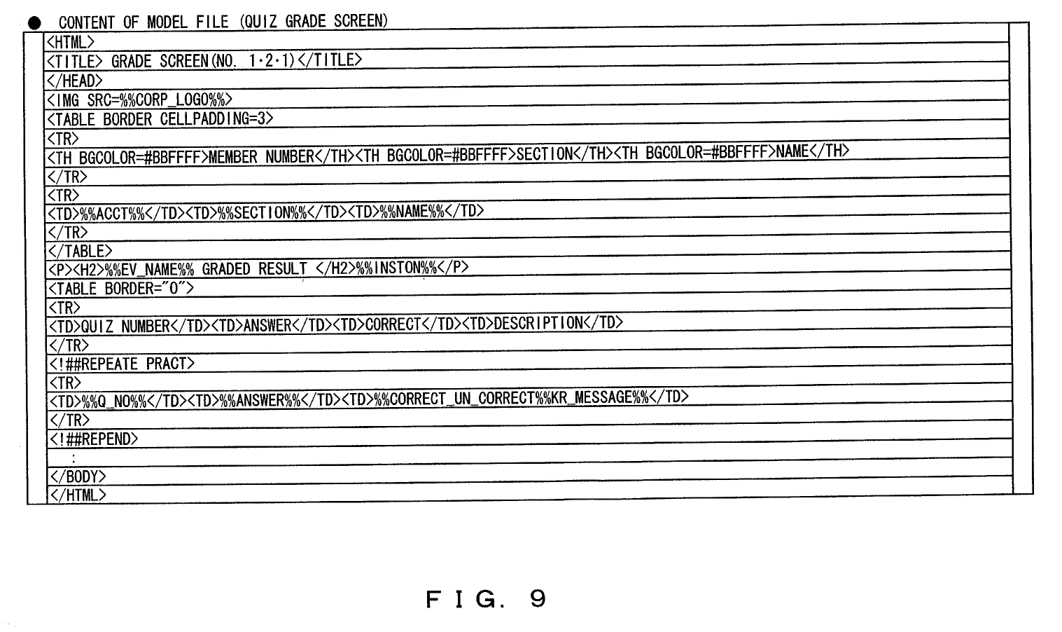

FIG. 9 shows the content of an HTML document of a grade screen.

Next, with reference to FIGS. 8 and 9, the process will be described in detail.

The account server performs the following process.

(1) Interpreting cgi Parameters

The account server inputs cgi parameters. The cgi parameters as input data are composed of a screen number (or a model name), a member number, a course code, a learning unit number, a quiz number, and learner's answer.

The account server outputs the content of the model file.

The account server interprets the input cgi parameters and separates them into individual items. For example, when the user answers a quiz on the quiz screen shown in FIG. 6, the account servers receives cgi parameters “acct =AAAAAA, course =UUA15Z, menu=g1211, event=EV03, Q1=a” as a cgi program of a HTML document.

(2) Inputting Model File Corresponding to Function Number

The account server inputs the cgi parameters and a model file.

The account server outputs each record of the model file.

The account server reads a model file corresponding to a screen number (or a model name). In the example, the account server reads a model file g1211 corresponding to a cgi parameter “menu=g1211”. FIG. 9 shows an example of a model.

(3) Asking Contents Server to Perform Process Corresponding to Content of Model File and Service Number

The account server inputs cgi parameters and records of a model file.

The account server outputs cgi parameters to the contents server.

Since there may be a plurality of contents servers, the account server designates a contents server corresponding to a course code and creates parameters that is output to the contents server. The account server creates parameters by adding the content of a model to the member number, the course code, the learning unit number, the quiz number, and learner's answer that the learner has input through the browser and asks the contents server corresponding to the course to perform the process.

In the example, the account server asks the contents server to perform the process with the cgi parameters “acct=AAAAAA, course=UUA15Z, menu=g1211, event=EV03, Q1=a” in addition to the content of the model shown in FIG. 9.

(4) Receiving Processed Result of Contents Server

After the contents server has completed the process, the account server receives an HTML document of which macros have been expanded from the contents server.

(5) Solving Macro Name (Variable) Unsolved in Contents Server

In this case, the account server inputs an HTML document of which macros have been expanded and a member information master and outputs an HTML document of which the macros have been expanded.

The account server references the member name master for an unsolved macro name and completes an HTML document of which macros have been expanded corresponding to an HTML document of which macros have been expanded in the contents server. In other words, the account server expands macros of items “company name”, “section name”, and “learner's name” defined as items of the member information of the model.

(6) Converting URL of Image and so Forth

The account server inputs an HTML document of which macros have been expanded, expands an image, and outputs an HTML document of which macros have been expanded. Although the reference of image data is designated as “<img src=aaa.gif>” in an HTML document, the user can see only the operation of the account server on his or her browser. Thus, to allow the user to reference image data from a proper contents server, the account server adds a URL such as “<img src=http://csl.oll.co.jp/xxxx/aaa.gif>”. In addition, the account server changes links. As a result, the account server completes the model expansion so as to allow a proper server to reference another file distributed to various servers.

(7) Outputting HTML Document of Which Macros Have Been Expanded

As a result, the account server outputs an HTML document of which macros have been expanded to the learner's browser.

On the other hand, the contents server side performs the following process.

(3. 1) Interpreting Content of Service Request

The contents server side inputs cgi parameters, learning data, and a course master and outputs separated cgi parameters. The contents server adds parameters of the content of the model shown in FIG. 9 to cgi parameters “acct=AAAAAA, course=UUA15Z, menu=g1211, event=EV03, Q1=a, . . . ” as a cgi program stored in the contents server. As a result, the contents server outputs parameters “template=↓<HTML>↓</TABLE>↓<P><h2>%%ev_name%% graded result </h2>%%inston%% </P>↓ . . . ”.

(3. 2) Performing Grade Process and Tecording Graded Result Log

The contents server inputs cgi parameters, learner's data, and a course master and outputs a graded result log. The contents server grades answers of the learner, determines whether the answers are correct or incorrect, calculates the score, and records the result to the graded result log. In the example, the contents server determines the course with a cgi parameter “course=UUA15Z”, determines the quiz with a cgi parameter “event=EV03”, and grades the answer of the learner of the quiz 1 with a cgi parameter “Q1=a”.

(3. 3) Creating Output Screen Corresponding to Model and Expanding Macro Names (Variables) of Model

The contents server inputs cgi parameters, learner's data, a course master, and a graded result log and outputs the content of an HTML document of which macros have been expanded. The contents server embeds macro names designated as variables such as “member number” and “quiz number” as real item data to the HTML document and expands the model. The contents server does not process hidden macro names “company name” and “section name”, but directly outputs them.

(3. 4) Outputting HTML Document as Created Result

The contents server sends the HTML document of which macros have been expanded to the account server.

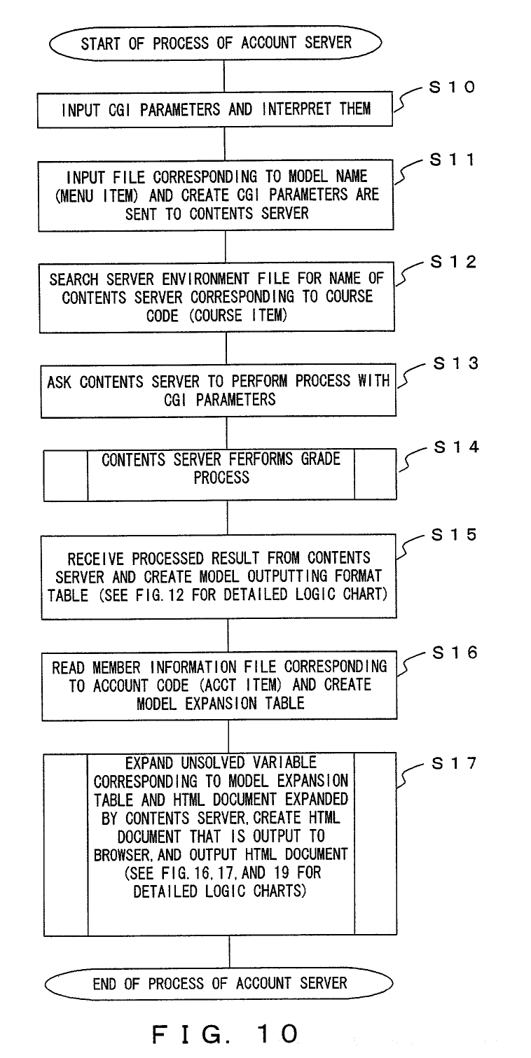

FIG. 10 is a flow chart showing a process of the account server.

At step S10, the account server inputs cgi parameters and interprets them. At step S11, the account server inputs a file name of a model name (menu item) and creates cgi parameters that are sent to the contents server. At step S12, the account server searches a server environment file for a requested contents serer name corresponding to a course code (course item).

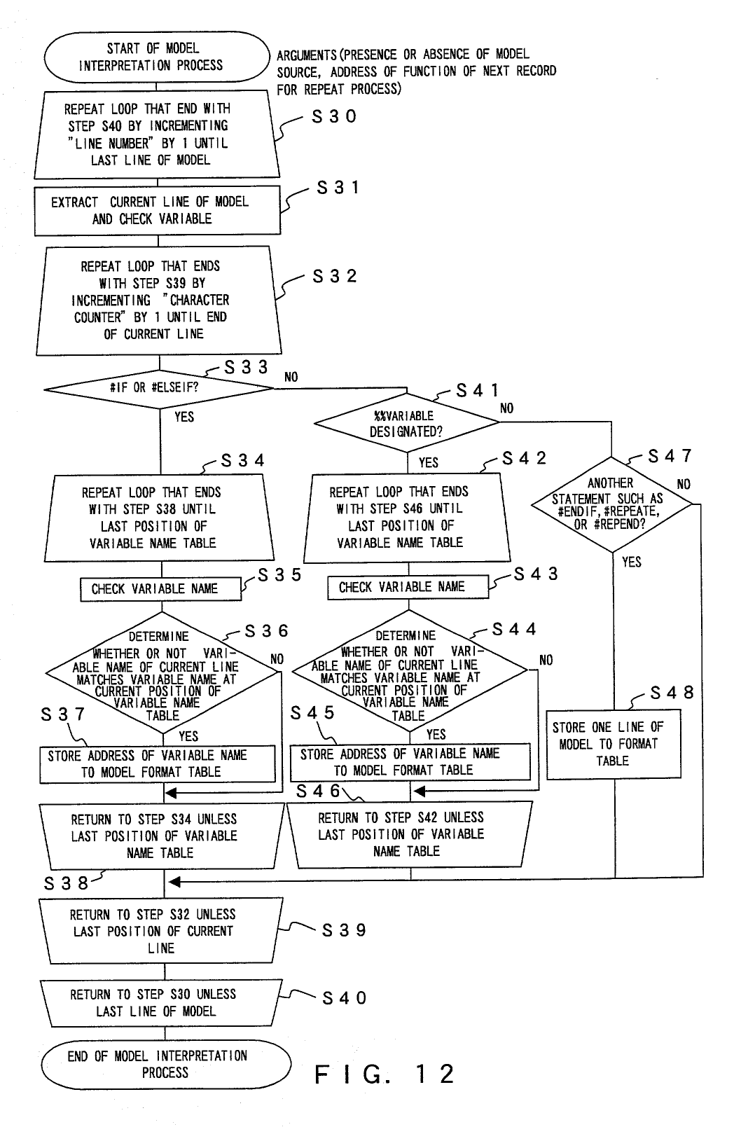

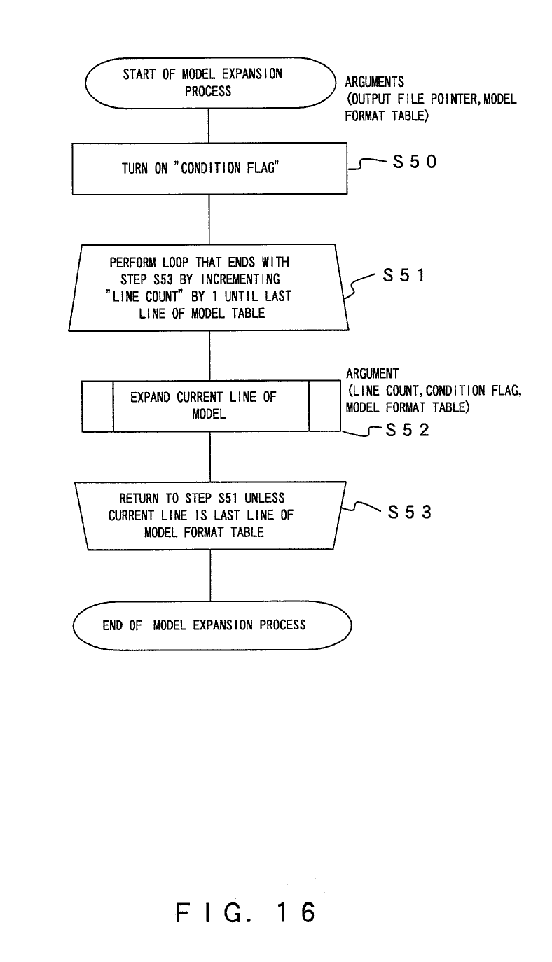

At step S13, the account server sends the cgi parameters to the contents server. At step S14, the contents server performs the grade process. At step S15, the account server receives the processed result of the contents server and creates a model output format table (see FIG. 12). At step S16, the account server reads a member information file corresponding to an account code (acct item) and creates a model expansion table. At step S17, the account server expands an unsolved variable corresponding to the model expansion table and the HTML document expanded by the contents server, creates an HTML document that is output to the browser, and outputs the created HTML document (see FIGS. 16, 17, and 18). Thereafter, the account server completes the processes.

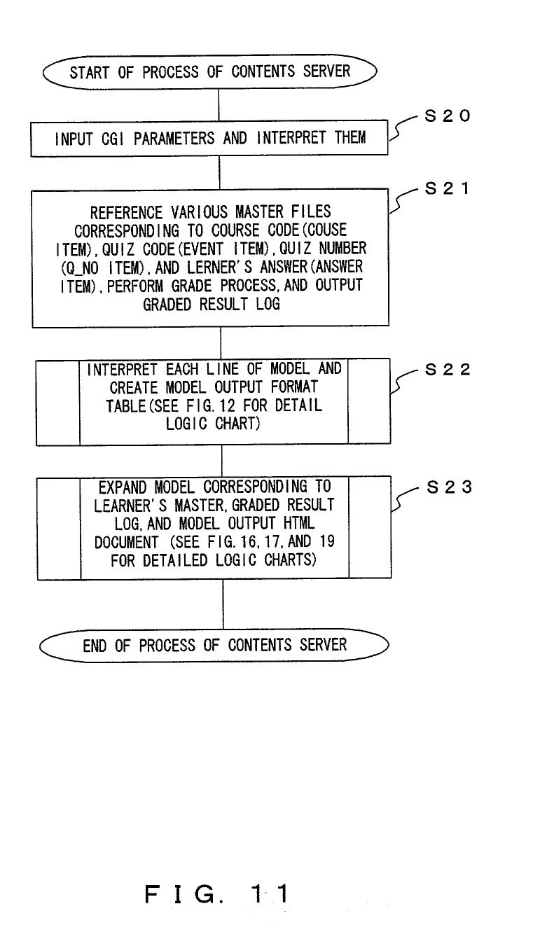

FIG. 11 is a flow chart showing a process of the contents server.

At step S20, the contents server receives cgi parameters from the account server and interprets them. At step S21, the contents server references various master files corresponding to course code (course item), quiz code (event item), quiz number (q_no item), and learner's answer (answer item), performs a grade process, and outputs a graded result log. At step S22, the contents server interprets each line of the model and creates a model output format table (see FIG. 12). At step S23, the contents server expands the model corresponding to the learner master, the course master, the graded result log, and the model output format table and outputs an HTML document (see FIGS. 16, 17, and 19). Thereafter, the contents server completes the process.

FIG. 12 is a flow chart for explaining a model interpretation process that is performed by the account server and the contents server. For simplicity, it is assumed that the model interpretation process is performed by the contents server.

As arguments of the process, the contents server designates the presence or absence of a model source, an address of a function of the next record for the repeat process, and so forth.

At step S30, the contents server starts a loop that ends with step S40. In other words, the contents server increments a “line number” by 1 until the last line of the model.

At step S31, the contents server extracts the current line from the model and checks a variable thereof. At step S32, the contents server repeats a loop that ends with step S39. In other words, the contents server increments a “character count” by 1 until the end of the current line.

At step S33, the contents server determines whether or not the current line is a #if statement or a #elseif statement. When the determined result at step S33 is No, the flow advances to step S41. When the determined result at step S33 is Yes, the flow advances to step S34.

At step 34, the contents server repeats a loop that ends with step S38 until the end of a variable name table. At step S35, the contents server checks the variable name of the current line. At step S36, the contents server determines whether or not the variable name of the current line matches the variable name at the current position of the variable name table. When the determined result at step S36 is No, the flow advances to step S38. When the determined result at step S36 is Yes, the flow advances to step S37. At step S37, the contents server stores the address of the variable name to the model format table. Thereafter, the flow advances to step S38. At step S38, the flow returns to step S34 unless the current position is the last position of the model format table.

At step S41, the contents server determines whether or not the current line contains “%%”. When the determined result at step S41 is No, the flow advances to step S47. When the determined result at step S41 is Yes, the flow advances to step S42.

At step S42, the contents server repeats a loop that ends with step S46. At step S43, the contents server checks the variable name of the current position of the variable name table. Thereafter, the flow advances to step S44. At step S44, the contents server determines whether or not the variable name of the current line matches the variable name at the current position of the variable name table.

When the determined result at step S44 is No, the flow advances to step S46. When the determined result at step S44 is Yes, the flow advances to step S45. At step S45, the contents server stores the address of the variable name to the model format table. Thereafter, the flow advances to step S46. At step S46, the flow returns to step S42 unless the current position is the last position of the model format table.

At step S47, the contents server determines whether or not the current line is another statement such as #endif, #repeate, or #repend. When the determined result at step S47 is No, the flow advances to step S39. When the determined result at step S47 is Yes, the flow advances to step S48. At step S48, the contents server stores the current line of the model to the model format table. Thereafter, the flow advances to step S39.

At step S39, the flow returns to step S32 unless the current character position is the last position. When the current character position is the last position, the flow advances to step S40. At step S40, the flow returns to step S30 unless the current line is the last line of the model. When the current line is the last line of the model, the contents server completes the model interpretation process.

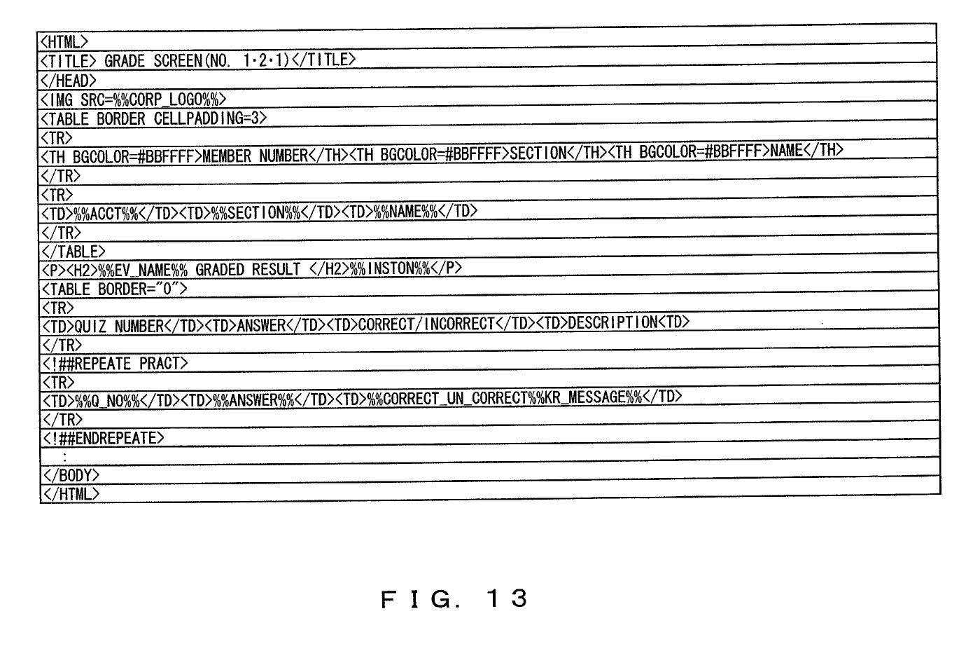

FIGS. 13 to 15 are schematic diagrams for explaining the model file interpretation process.

FIG. 13 is a schematic diagram showing an example of a model source file that is input in the model interpretation process.

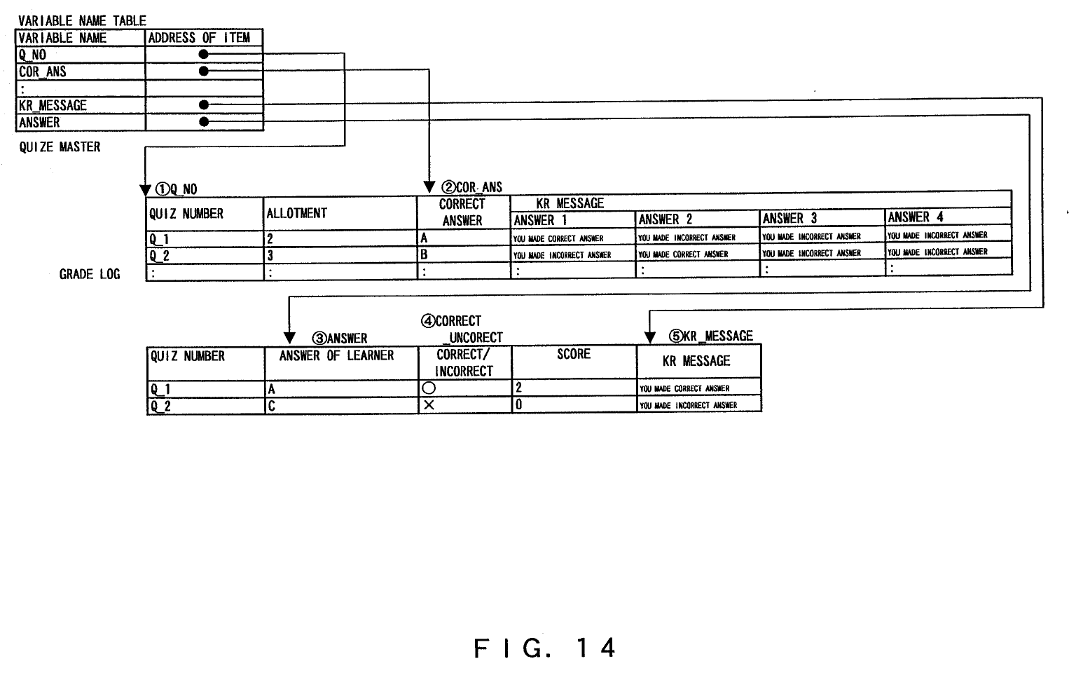

As shown in FIG. 12 as a flow chart, the contents server extracts a variable from the model source file and compares the extracted variable with the variable name table. As shown in FIG. 14, the variable name table contains various variable names and address values of tables of real values of variables (variable values after the grade process has been performed). In FIG. 14, “q_no” of the quiz master table represents a quiz number that the user has answered. “cor_ans” of the quiz master table represents an correct answer of the quiz. “answer” of the quiz master table represents an answer of the learner of the graded log table (obtained after the grade process). “kr_message” of the quiz master table represents a KR message that notifies the user whether the his or her answer is correct or incorrect. In addition, corresponding to a variable “correct_un_correct”, an address that allows a variable value that represents whether the learner's (user's) answer is correct or incorrect to be obtained is designated (not shown in FIG. 14).

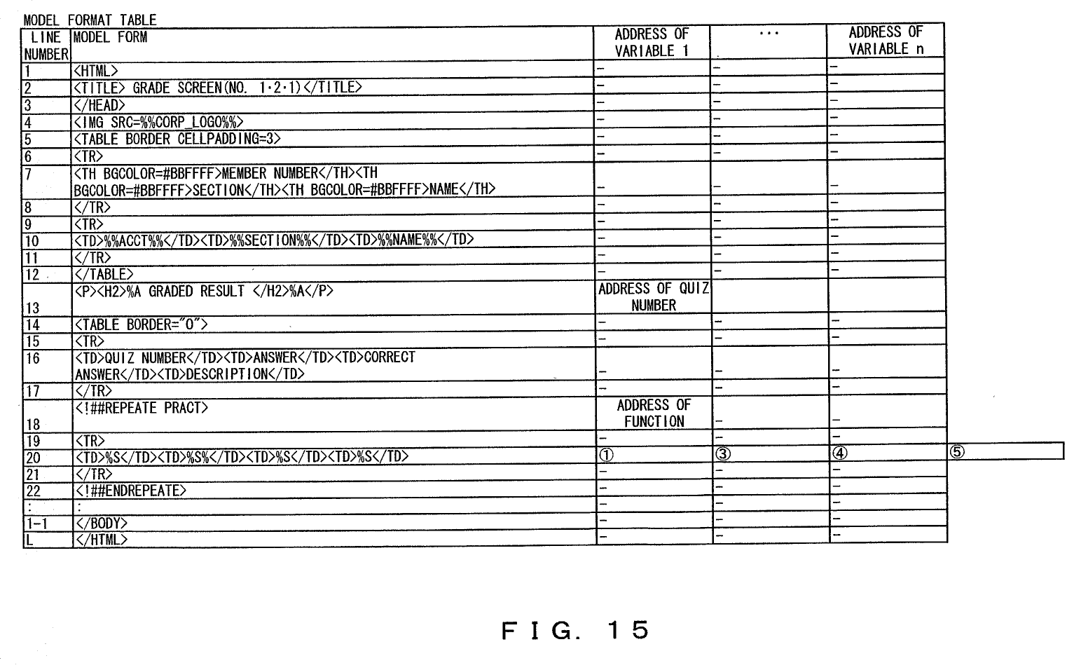

FIG. 15 is a schematic diagram showing an example of a model format table that is output. The model format table is tabulated for each model form corresponding to each line. The model format table has variable value fields that contain addresses of substitute values of individual variables. In FIG. 15, for simplicity, the model format table contains addresses of variables 1 to n. However, actually, the number of address values of individual lines depends on the number of variables designated thereto.

FIG. 16 is a flow chart for explaining a model expansion process.

In the example, as arguments of the logic, the contents server inputs a line count, a condition flag, and a model format table.

First of all, as arguments of the model expansion process, the contents server inputs an output file pointer and a model format table.

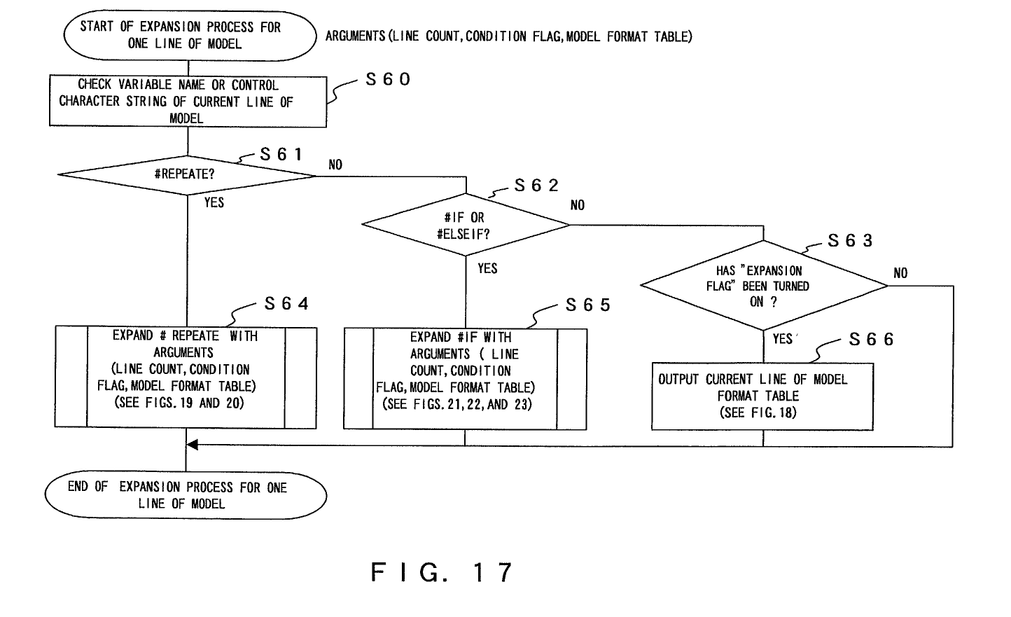

At step S50, the contents server turns on a “condition flag” that will be used later. At step S51, the contents server repeats a loop that ends with step S53. At step S51, the contents server increments a “line count” by 1 until the last position of the model format table. At step S52, the contents server expands one line of the model. The expansion process will be described later in detail with reference to FIG. 17. At step S52, the contents server inputs a line count, a condition flag, and a model format table as arguments. At step S53, the flow returns to step S51 unless the current line is the last line of the model format table. When the current line is the last line of the model format table, the contents server completes the model expansion process.

FIG. 17 is a flow chart showing the expansion process for one line of a model.

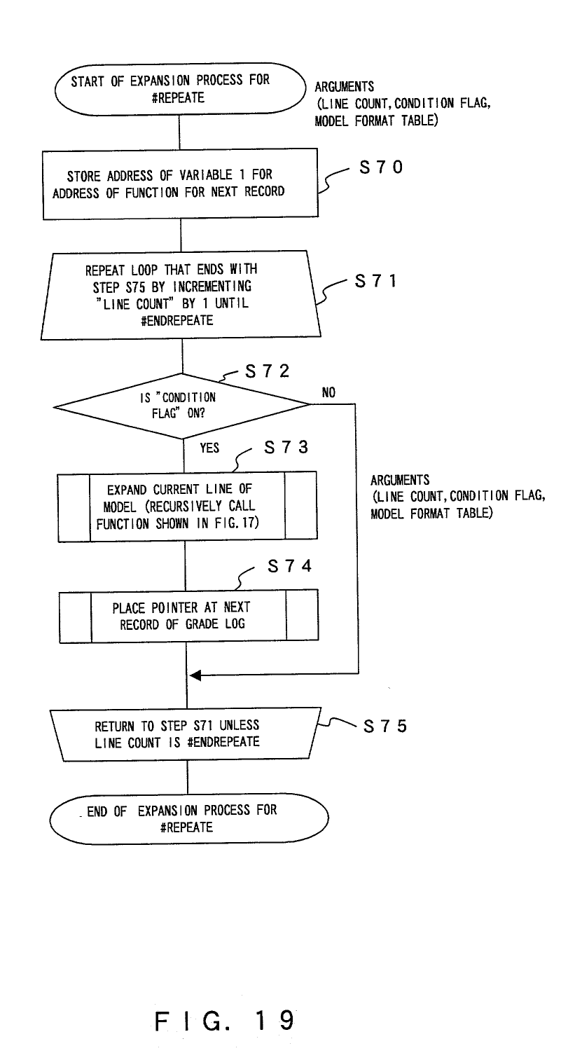

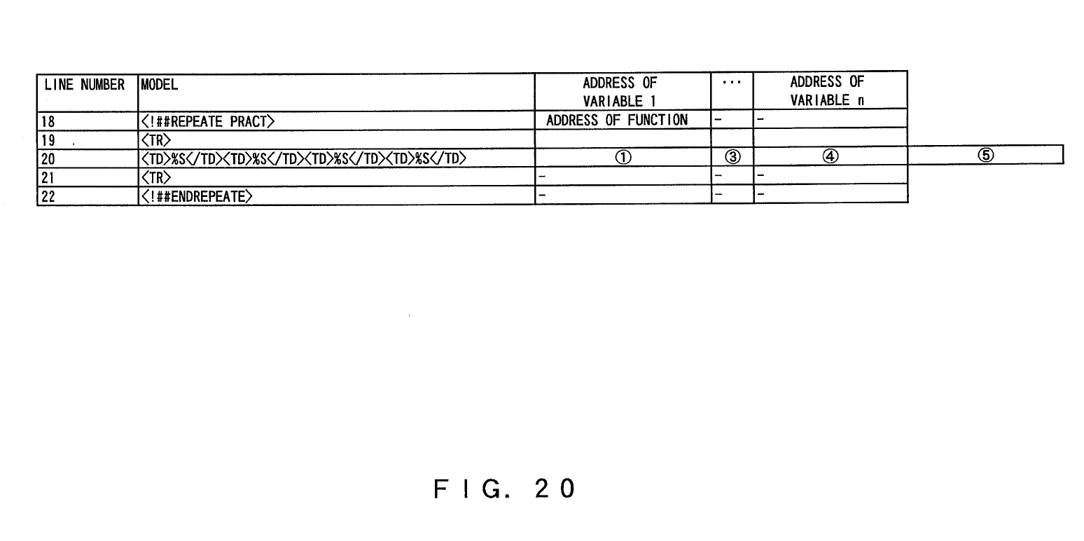

At step S60, the contents server checks a variable name or a control character string of the current line of the model. At step S61, the contents server determines whether or not the character string is #repeate. When the determined result at step S61 is No, the flow advances to step S62. When the determined result at step S61 is Yes, the flow advances to step S64. At step S64, the contents server expands #repeate and completes the expansion process of the current line of the model. The detail of step S64 will be described later with reference to FIGS. 19 and 20.

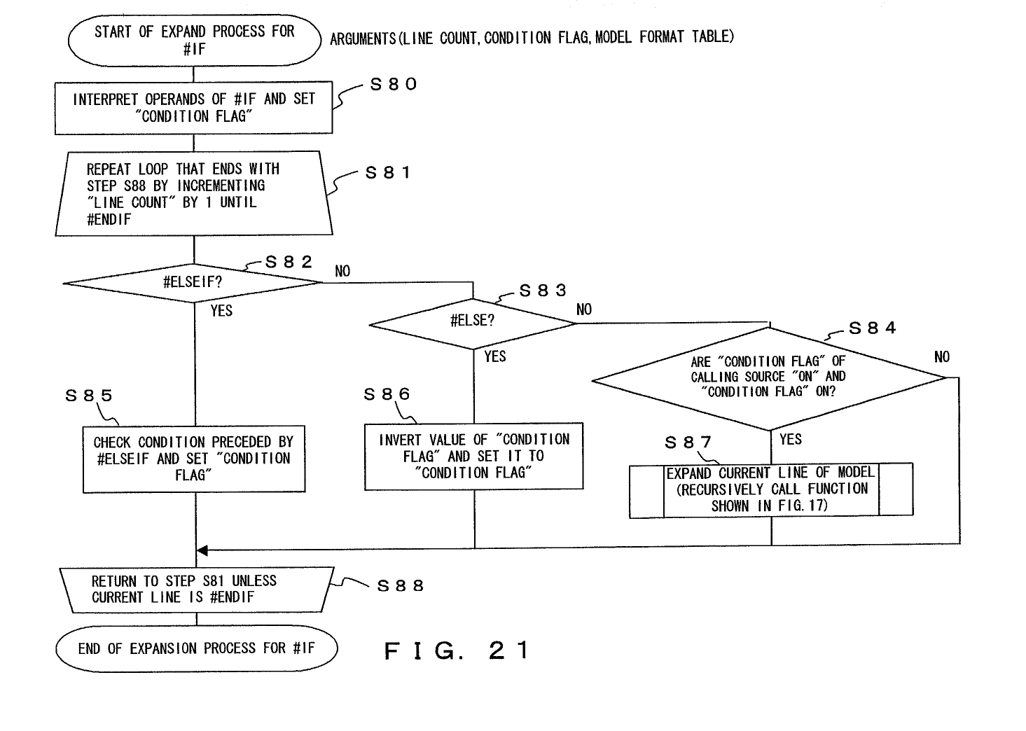

At step S62, the contents server determines whether or not the character string is #if or #elseif. When the determined result at step S62 is No, the flow advances to step S63. When the determined result at step S62 is Yes, the flow advances to step S65. At step S65, the contents server expands #if. The detail of step S65 will be described later with reference to FIGS. 21, 22, and 23.

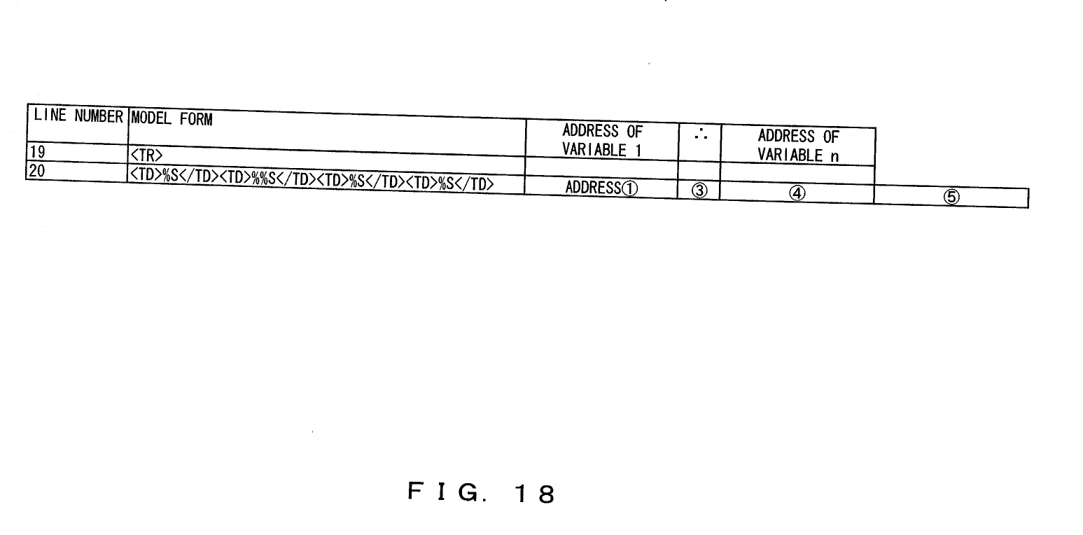

At step S63, the contents server determines whether or not the “condition flag” is ON. When the determined result at step S63 is No, the contents server completes the process. When the determined result at step S63 is Yes, the flow advances to step S66. At step S66, the contents server outputs the current line of the model format table and completes the process. The detail of step S66 will be described later with reference to FIG. 18.

FIG. 18 is a schematic diagram for explaining the process of step S66 shown in FIG. 17.

When the current line is neither a #if statement nor a #repeate state, the contents server outputs variables 1 to n corresponding to the model forms. In line 19 shown in FIG. 18, since no addresses are designated to the variables 1 to n, the contents server outputs only <tr>. In line 20 shown in FIG. 18, the contents server outputs the variables (1), (3), (4), and (5) corresponding to the model form. The variables (1), (3), (4), and (5) are for example the address of the quiz number, the answer of the learner, the correct/incorrect, and the KR message, respectively.

FIGS. 19 and 20 are a flow chart and a schematic diagram for explaining an expansion process for #repeate.

The logic shown in FIG. 19 requires a line count, a condition flag, and a model format as arguments.

At step S70, the contents server stores the address of the variable 1 for the address of the function of the next record. In other words, the contents server stores the address of the variable 1 of the line 18 shown in FIG. 20 (as address (6)). At step S71, the contents server repeats a loop that ends with step S75. In other words, the contents server increments the “line count” by 1 until #endrepeate. At step S72, the contents server determines whether or not the “condition flag” is ON. When the determined result at step S72 is No, the flow advances to step S75. When the determined result at step S72 is Yes, the flow advances to step S73. At step S73, the contents server expands the current line of the model. This process requires a line count, a condition flag, and a model format table as arguments. At step S73, the contents server recursively calls the function logic shown in FIG. 17. At step S74, the contents server places the pointer to the next record of the grade log. Thereafter, the flow advances to step S75. In other words, at step S74, the contents server calls the function at address (6) and places the pointer to the record of the next quiz of the grade log. Thereafter, the flow advances to step S75. At step S75, the flow returns to step S71 unless the current line is #endrepeate. When the current line is #endrepeate, the contents server completes the expansion process for #repeate.

FIGS. 21 to 23 are a flow chart and schematic diagrams for explaining an expansion process for an #if statement.

The logic shown in FIG. 21 requires a line count, a condition flag, and a model format table as arguments.

At step S80, the contents server interprets the operands of a #if statement and sets the “condition flag”. Thereafter, at step S81, the contents server repeats a loop that ends with step S88 by incrementing the “line count” by 1 until #endif.

At step S82, the contents server determines whether or not the character string of the current line is #elseif. When the determined result at step S82 is No, the flow advances to step S83. When the determined result at step S82 is Yes, the flow advances to step S85. At step S85, the contents server checks the condition preceded by #elseif and sets the “condition flag”. Thereafter, the flow advances to step S88.

At step S83, the contents server determines whether or not the character string of the current line is #else. When the determined result at step S83 is No, the flow advances to step S84. When the determined result at step S83 is Yes, the flow advances to step S86. At step S86, the contents server inverts the value of the “condition flag” and sets the resultant value to the “condition flag”. Thereafter, the flow advances to step S88.

At step S84, the contents server determines whether or not the “condition flag” of the calling source is ON and the “condition flag” is ON. When the determined result at step S84 is No, the flow advances to step S88. When the determined result at step S84 is Yes, the flow advances to step S87. At step S87, the contents server expands the current line of the model. In the process, the contents server recursively calls the function shown in FIG. 17. Thereafter, the flow advances to step S88.

At step S88, the flow returns to step S81 unless the current line is #endif. When the current line is #endif, the contents server completes the expansion process for #if.

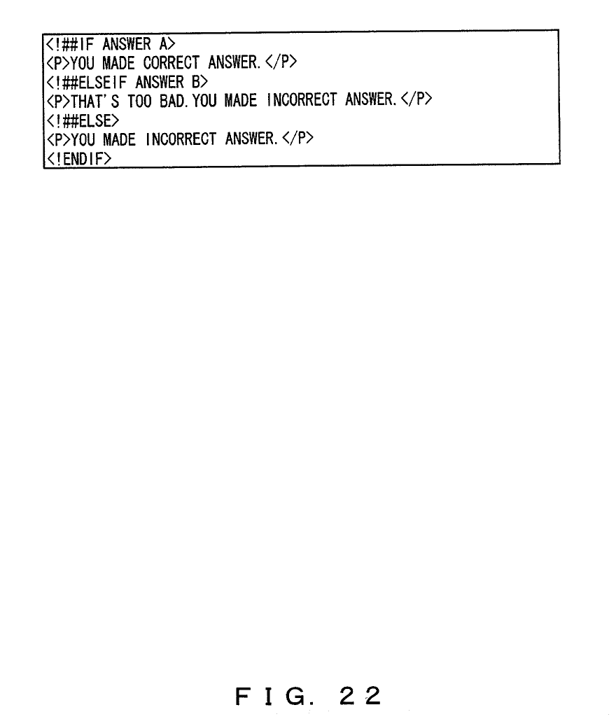

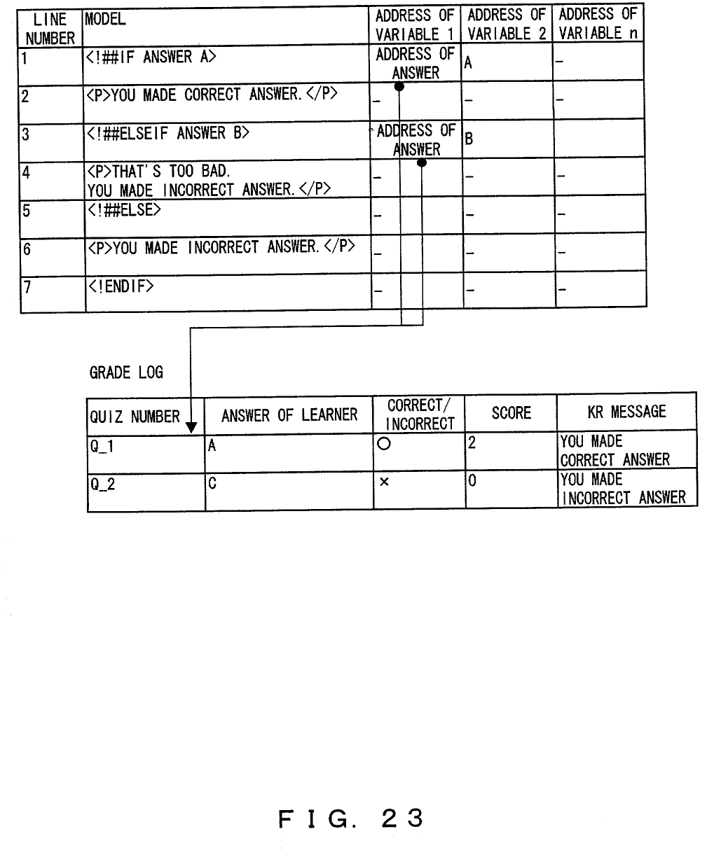

FIG. 22 is a schematic diagram showing an example of a model source file of a #if statement. FIG. 23 is an example of a model format table. FIG. 22 shows messages corresponding to the cases that the answer of the learner is “A”, that the answer of the learner is “B”, and that the answer of the learner is neither “A” nor “B”. In FIG. 23, an address of the answer of the quiz Q1 can be designated with <!##if answer A>. Likewise, an address can be designated with <!##elseif answer B>. In the real process, the content of an answer that is represented by an address is substituted with the grade log in the expansion process. The learner is notified of a message that represents whether his or her answer is correct or incorrect.

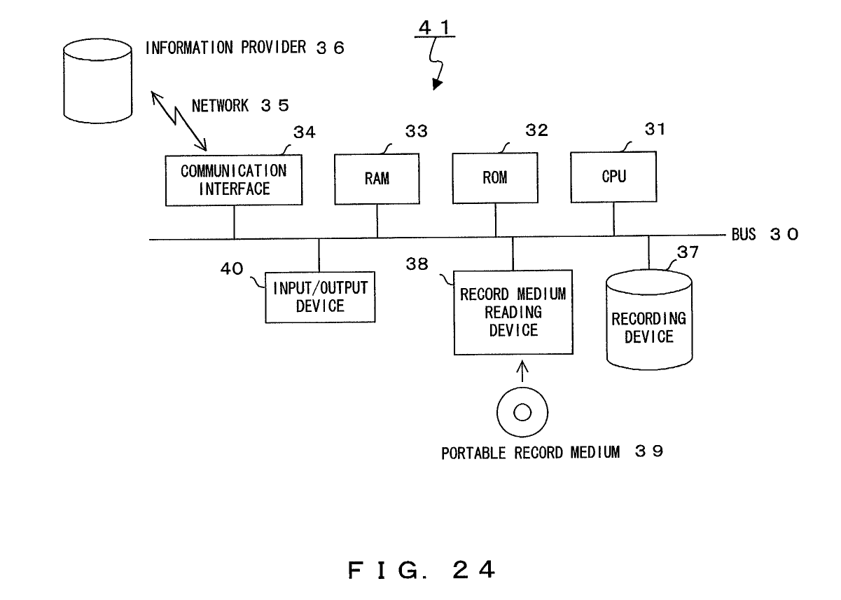

FIG. 24 is a block diagram showing the hardware structure of an information apparatus necessary for accomplishing the process logic (algorithm) of the embodiment of the present invention as a program.

An information apparatus 41 may be an account server or a contents server. A program for each process of the account server or contents server is stored in a recording device 37 such as a hard disk or a portable record medium 39 such as a CD-ROM, a floppy disk, an MO, or a DVD. When the program is stored in the recording device 37, a CPU 31 connected to the recording device 37 through a bus 30 copies the program to a RAM 33 so that the program is executed. On the other hand, when the program is stored in the portable record medium 39, using a record medium reading device 38, the CPU 31 copies the program to the RAM 33 so that the program is executed.

Alternatively, the program may be stored to a ROM 32 connected to the CPU 31 and the bus 30. The information apparatus 41 may be used as a dedicated account server device or a dedicated contents server device. In addition, the ROM 32 stores a BIOS that allows the user to use an input/output device 40. The input/output device 40 is composed of for example a keyboard, a display device, a mouse, and a tablet. With the input/output device 40, the user can perform a required maintenance work and perform an install operation for the program to the information apparatus 41.

A communication interface 34 communicates with an information provider 36 through a network 35. The communication interface 34 allows the program to be downloaded from a database of the information provider 36 and stored to the recording device 37 or the portable record medium 39. The program is installed so that it is executable in the information apparatus 41. Alternatively, the program can be executed under the network environment through a communication with the information provider 36. In such a case, it is not necessary to download the program.

The communication interface 34 can be used for a communication between the account server and the contents server and a communication between the account server and a user terminal unit.

According to the present invention, the user can use a conventional ASP service as if he or she operated a customer company system. When a conversion logic and a table are properly created, customer information (for example, user names) can be hidden from the ASP.

As a result, a remarkable advantage is obtained for a WBT (Web Based Training) that has to use personal information through the ASP.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A customizing method for allowing a service provided by a service provider to be customized for a user who uses the customized service through a network, comprising:
(a) storing conversion information that causes information transmitted from the service provider to be customized for the user and information transmitted from the user to be converted into a format of the service provider; and
(b) converting the information transmitted from the service provider into a format of the user and converting the information transmitted from the user into a format of the service provider using the conversion information.

2. The customizing method as set forth in claim 1,
wherein the information is transmitted as an HTML document.

3. The customizing method as set forth in claim 1,
wherein the conversion information is composed of model files for the service provider and the user and a table that contains data substituted into variables of the model files.

4. The customizing method as set forth in claim 1,
wherein the service provider is an ASP (Application Service Provider).

5. The customizing method as set forth in claim 1,
wherein the ASP provides an online learning service.

6. A record medium for storing a program that causes an information apparatus to accomplish a customizing method for allowing a service provided by a service provider to be customized for a user who uses the customized service through a network, comprising:
(a) storing conversion information that causes information transmitted from the service provider to be customized for the user and information transmitted from the user to be converted into a format of the service provider; and
(b) converting the information transmitted from the service provider into a format of the user and converting the information transmitted from the user into a format of the service provider using the conversion information.

7. The record medium as set forth in claim 6,
wherein the information is transmitted as an HTML document.

8. The record medium as set forth in claim 6,
wherein the conversion information is composed of model files for the service provider and the user and a table that contains data substituted into variables of the model files.

9. The record medium as set forth in claim 6,
wherein the service provider is an ASP (Application Service Provider).

10. The record medium as set forth in claim 9,
wherein the ASP provides an online learning service.

11. A customizing system for allowing a service provided by a service provider to be customized for a user who uses the customized service through a network, comprising:
a customized information storing unit storing conversion information that causes information transmitted from the service provider to be customized for the user and information transmitted from the user to be converted into a format of the service provider; and
a converting unit converting the information transmitted from the service provider into a format of the user and converting the information transmitted from the user into a format of the service provider using the conversion information.

12. The customizing system as set forth in claim 11,
wherein the information is transmitted as an HTML document.

13. The customizing system as set forth in claim 11,
wherein the conversion information is composed of model files for the service provider and the user and a table that contains data substituted into variables of the model files.

14. The customizing system as set forth in claim 11,
wherein the service provider is an ASP (Application Service Provider).

15. The customizing system as set forth in claim 14,
wherein the ASP provides an online learning service.
